(19) United States
(12) Patent Application Publication
(10) Pub. No.: US 2011/0177727 A1
(43) Pub. Date: Jul. 21, 2011

(54) ALUMINUM CONDUCTOR AND CONDUCTIVE TERMINAL CONNECTION

(76) Inventor: Weiping Zhao, Superior Twp, MI (US)

(21) Appl. No.: 12/689,225

(22) Filed: Jan. 18, 2010

(51) Int. Cl. H01R 4/02

(52) U.S. Cl. 439/874

(57) ABSTRACT

A conductive terminal is a feasible of making a reliable and cost effective electrical connection between the aluminum conductor and any metal conductor. The terminal includes a blank, a three dimensional structure formed from the blank, and multiple seams and a slit being sealed by a metal filler. It has a transition opening to allow melted metal to flow in and make a metallic bond between terminal and the aluminum conductor. The folded two arms with the metallic seals provide sealing surface for adhesive shrinkable tube. An assembly of terminal and the aluminum conductor includes a compressed the aluminum conductor within a terminal hollow tube, a metallic bond and coating, an metallic seals at a slit and multiple seams. The shrinkable adhesive tube seals the connection of the aluminum conductor and conductive terminal from environmental fluids at multiple locations. These locations start from the two arms with metallic seals, the transition opening, non-deformed hollow tube of the terminal, and the insulation of the aluminum conductor. The metallic bond and coating also isolate the aluminum conductor from air.

### BACKGROUND OF THIS INVENTION

1. Field of the Invention

The invention relates to a terminal structure that makes a reliable and cost effective connection between the aluminum conductor and conductive terminal. The three dimensional terminal structure is formed from a blank, which can be economically produced in various shapes and structures in progression die. The terminal transition opening provides a window for allowing melted metal alloys to flow in to reach the aluminum conductor. This feature makes the feasibility to use existing manufacturing processes such as dip soldering, wave soldering, and reflow soldering but not limited to these processes. Multiple features provide sealable surfaces after applied shrinkable adhesive tubes.

The aluminum conductor has cost and weight advantages over copper conductor. In the past, numerous efforts have been conducted to connect the aluminum conductor and copper. The contact of the aluminum and copper, if any fluids are applied, produces corrosion. The surface of the aluminum conductor is easily oxidized. In the long run, the aluminum conductor tends to soften. A corrosive, oxidized, and crept aluminum conductor increases the electrical resistance between the aluminum conductor and copper conductor, which causes a mal-function in the electrical connection.

2. Description of the Prior Art

One aluminum and terminal connection is disclosed in US Pub 2006/0292922 A. A high temperature process like plasma is used to weld the zinc at front of the aluminum conductor. This requires a special equipment and procedure to apply and weld zinc. The nickel plating or any plating nearby welded zinc is burned off. So, the copper base metal is exposed. The zinc has much higher voltage potential difference to copper material than the voltage potential difference between the aluminum to copper. Therefore, corrosion is possible developed at zinc when any fluids present.

Other aluminum and terminal connection is disclosed in US Pub 2006/0208838 A1. It uses multiple steps and special equipments to make connection between the aluminum conductor and conductive element. The conductive element is tube type shape. This limits its applications.

These special requirements diminish the benefit of cost saving by using the aluminum conductor instead of a copper conductor. Therefore, it is desirable to provide a reliable, various shapes, and economical sound connection.

### SUMMARY OF THIS INVENTION

The forgoing invention terminal has a terminal tongue, a hollow tube, a transition section connected to the terminal tongue, and a hollow tube. The terminal material is made of copper, brass, bronze, or any other conductive metals. This terminal style can be produced in a progression die. So, the terminal tongue can be made into various shapes and three dimensional structures. The typical shapes are I, L, J, or angular shape. The typical structure like any complex battery terminal fits directly into a battery post. The transition section contains two folded arms (cross section like a V-shape or a rectangular shape). Each of the two arms is at least one material thickness. The two arms form a seam at the middle of terminal tongue and a slit against the terminal tongue. The transition section then has a transition opening with a specified shape. It ends to connect the hollow tube. The hollow tube can be a cylindrical shape or an oval shape with the top seam.

The blank has a tongue portion, two arms, two specified undercuts, and a rectangular portion. During the forming process, the tongue portion stays the same shape. The two arms and the area with two specified undercuts are formed into three dimensional transition sections while the rectangular portion is formed into the corresponding hollow tube.

The metal filler is any one of the meltable metal alloys such as any solder alloys, but is not limited to these solder alloys. Depending on certain applications, the melted metal filler is applied on at least one side of two-arms and top seam of hollow tube before the terminal is compressed with the aluminum conductor. The cooled metal filler forms a metallic seals along at least one side of the slit and the seam of two-arms. Also, the metallic seal is formed along the top seam of the hollow tube.

For more future operations, the transition opening allows the melted metal filler flowing in to make metallic bonds between the aluminum conductor and the terminal conductor. The transition opening provides a feasible way to use existing soldering processes such as dip soldering, wave soldering, and reflow soldering but not limited to these processes. Therefore, it reduces the cost by not using special processes and equipments. Two-arms, two metallic seals, and the edge of the transition opening provide a unique sealing structure for the shrinkable adhesive tube.

The aluminum conductor is jacked by insulation. A certain length of insulation is peeled off. The inside diameter of the hollow tube is bigger than the outside diameter of the aluminum conductor. After the aluminum conductor is inserted into the terminal hollow tube, a specified clearance is created.

A bias pressure is applied on the certain compressed length from the outside hollow tube such that the hollow tube and the aluminum conductor are deformed, where joint assembly is then formed. Therefore, a high normal force is achieved between the aluminum conductor and the deformed hollow tube within compressed length. The compressed length maintains certain electrical integrity and mechanical retention between the aluminum conductor and the deformed hollow tube. A certain clearance length of the hollow tube and its inside aluminum conductor is not deformed. The clearance is still maintained between the non-deformed hollow tube and the aluminum conductor.

With the joint assembly, a melted metal filler is applied into the clearance length. A metallic bond is formed inside clearance area. At the same time, a metallic coating is formed on the end surface of the aluminum conductor. The length of the metallic bond and perimeter of the aluminum conductor are pre-specified so that the metallic bond provides certain electrical and mechanical integrities between the aluminum conductor and the conductive hollow tube. The metallic coating isolates the end surface of the aluminum conductor from the air.

For certain applications, metallic seals are not formed before compressing the aluminum conductor into hollow tube. For these cases, the melted metal filler is applied on at least one side of the two-arms and the top seam of the hollow tube. This forms a metallic seal along the slit and the seam of two-arms, and a metallic seal along the top seam of hollow tube. Again, the transition opening, two-arms, and metallic seals offer many advantages mentioned before. Additionally, it may use only one operation to produce metallic seals, the metallic bond, and the metallic coating.

The inside of a shrinkable adhesive tube is coated with adhesive material. The adhesive tube is jacked over the joint assembly. It shields the certain insulation length of the aluminum conductor all the way to the two-arms. Under the heat, the adhesive tube is shrunken tightly to fit the outside contour of the joint assembly. The two-arms and its metallic seal are nested or glued into adhesive material of the shrunken tube. Consequently, the covered length is sealed up from foreign fluid intruding at the two-arm. The transition opening is nested and sealed along its edge within the adhesive material of the shrunken tube. The outside surface of the non-deformed hollow tube and its metallic seal are glued and sealed within the adhesive material of the shrunken tube. The adhesive tube is shrunken such that the insulation length is tightly glued and sealed from the environment.

### BRIEF DESCRIPTION OF THE DRAWINGS

FIG. 1 is a perspective view of a conductive terminal

FIG. 2 is a section view of FIG. 1

FIG. 3 is a is a top view of the blank of conductive terminal

FIG. 4 is a perspective view of a conductive terminal with metallic seals at slit and seams.

FIG. 5 is a longitudinal section view of a terminal conductor after inserted the aluminum conductor

FIG. 6 is a longitudinal section view of a compressed terminal and the aluminum conductor

FIG. 7 is same FIG. 6 but with the metallic bond, metallic coating, and metallic seals

FIG. 8 is a transverse section view taken at A-A of FIG. 7

FIG. 9 is a perspective view of with metallic bond, coating, metal fillers at seams and slit;

FIG. 10 is a perspective view of the terminal and the aluminum assembly sealed by adhesive tube

FIG. 11 is a longitudinal section view of FIG. 10

FIG. 12 an angular section view taken at B-B of FIG. 11

### DESCRIPTION OF THE PREFFERED EMBODIMENTS

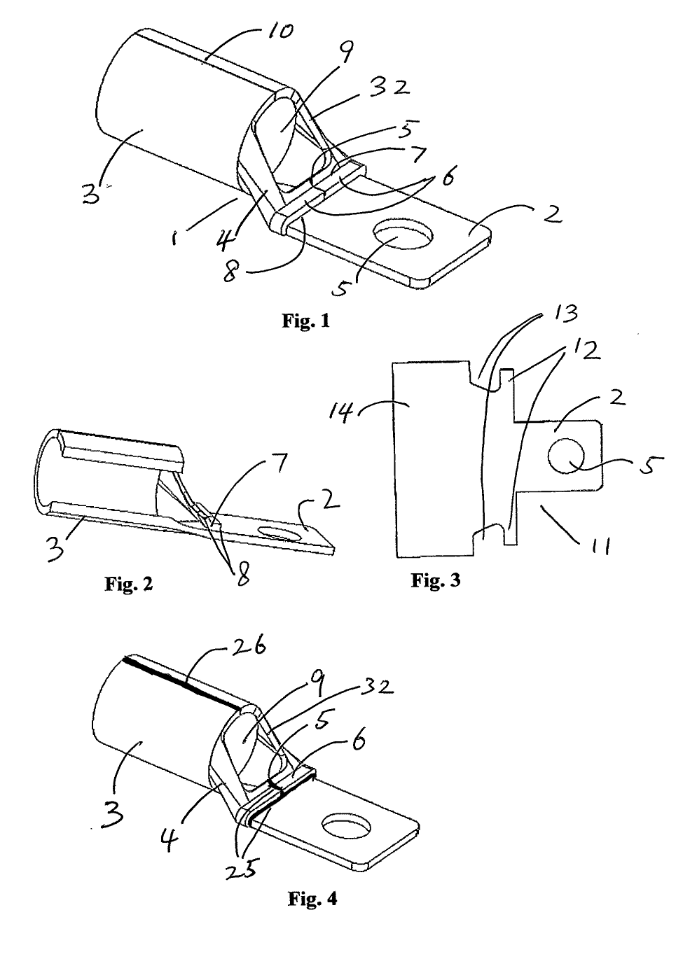

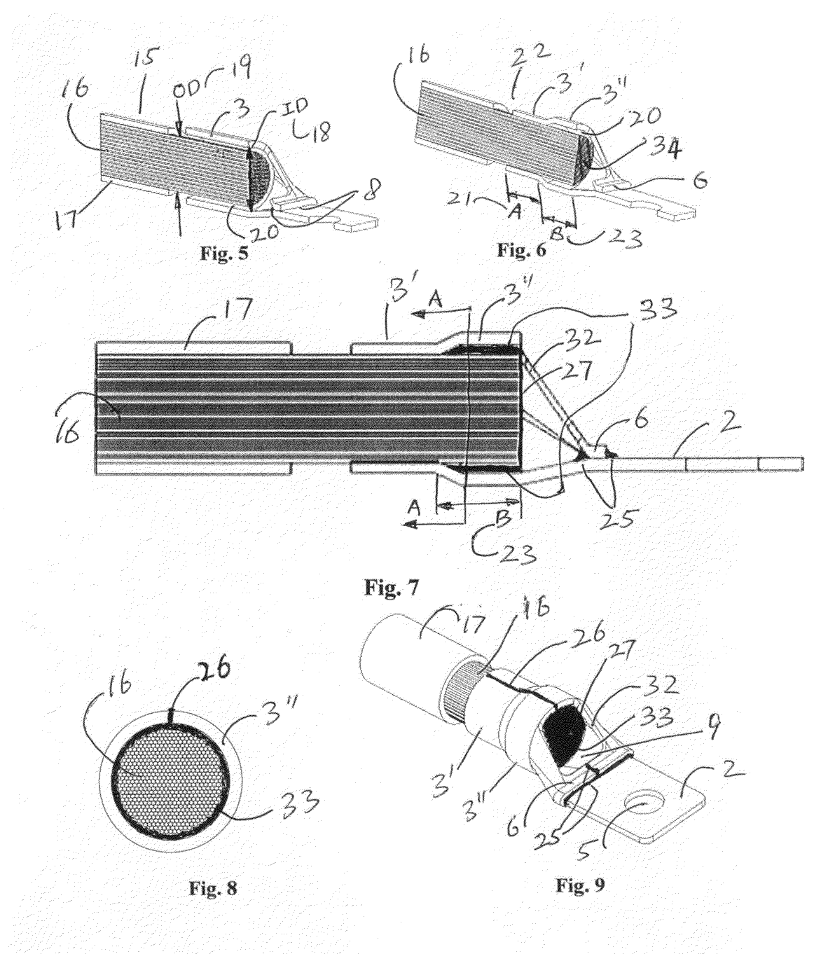

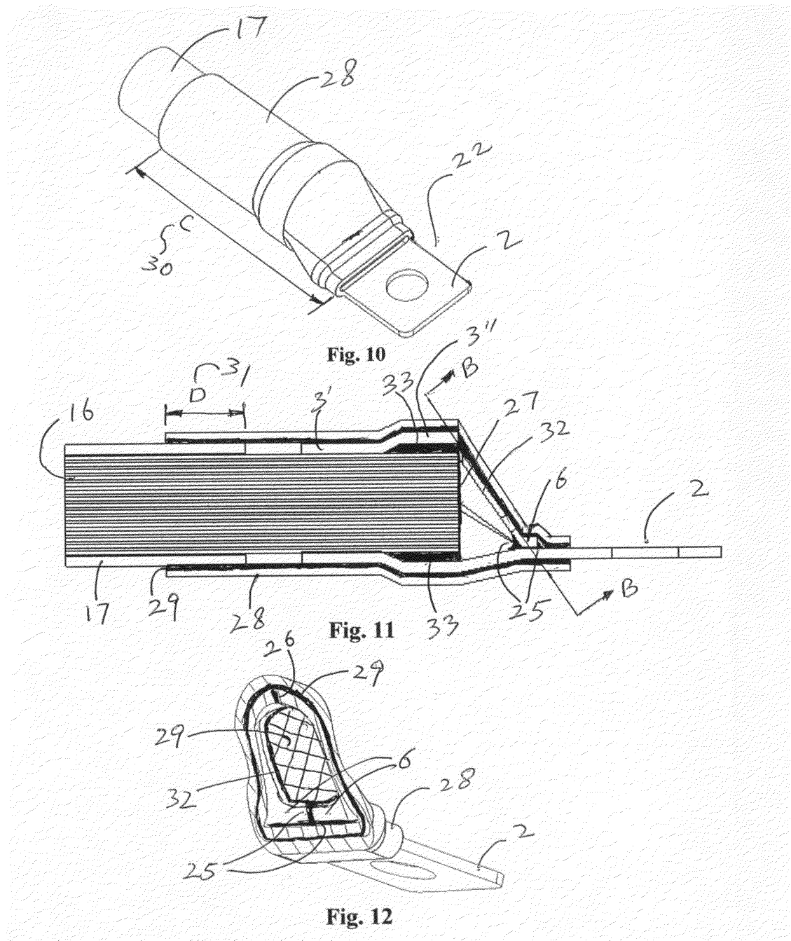

Referring to FIG. 1, the forgoing invention conductive terminal 1 consists of a terminal tongue 2, a hollow tube 3, a transition section 4 connected the terminal tongue 2, and a hollow tube 3. The terminal material can be copper, brass, bronze, or any other conductive metals. Since this terminal is produced in a progression die, the terminal tongue 2 can be made in various shapes and three dimensional structures. The typical shapes are I-shape terminal tongue 2, L, J, or angular shape terminal tongue (not shown). The terminal tongue 2 has a specified hole 5 which provides a connection to other electrical devices by tightening a pair of bolts and nuts through this hole. The typical three dimensional structure like any conventional and non-conventional battery terminal (not shown) directly fits into a battery post. The transition section 4 starts with two folded arms 6, with an arm cross section 7 like a V-shape in FIG. 1 and FIG. 2 (the cut off view of FIG. 1), or a rectangular shape (not shown). Each of the two arms is at least one material thickness. The two-arms 6 form a seam 5 at the middle of terminal tongue and form a slit 8 between terminal tongue 2 and two-arms 6. The transition section then has a transition opening 9 with a specified shape. It ends to connect the hollow tube 3. The hollow tube 3 can be a cylindrical shape or an oval shape with top seam 10.

Referring to FIG. 3, the terminal is formed from a metal blank 11. The blank has a tongue portion 2, two arms 12, two specified undercuts 13, and a rectangular portion 14. During the forming process, the tongue portion 2 stays at the same shape. The two arms 12 and the area with two specified under cuts 13 are formed into three dimensional transition section 4 in FIG. 1 while rectangular portion 14 is formed into the corresponding hollow tube 3 in FIG. 1.

Referring to FIG. 4, the metal filler is one of any meltable metal alloys such as any solder alloy, but is not limited to these solder alloys. Again, depending on applications, the melted metal filler is applied on at least one side of two-arms 6 and top seam 10 of hollow tube before compressing hollow tube with the aluminum conductor. Cooled metal filler forms the metallic seal 25 along at least one side of the slit 8 and the seam 5 of two-arms 6, and the metallic seal 26 along the top seam 10 of hollow tube 3. The transition opening 9 allows melted metal filler flowing in to make any metallic bonds between the aluminum conductor and terminal conductor. The transition opening provides a feasible way to use existing soldering processes such as dip soldering, wave soldering, and reflow soldering but not limited to these process. Therefore, it reduces the cost by not using special processes and equipments. Two-arms 6, two metallic seals 25 and 26, the edge of transition opening, and hollow tube 3 provide a unique sealing structure for the shrinkable adhesive tube.

Referring now to FIG. 5, the aluminum cable 15 consists of the aluminum conductor 16 and insulation 17. A certain length of insulation is peeled off. The inside diameter ID18 of hollow tube is bigger than the outside diameter OD 19 of the aluminum conductor 16. The aluminum conductor 16 is inserted into the terminal hollow tube 3. A specified clearance 20 is created.

Referring to FIG. 6, a bias pressure is applied on the certain said compressed length A 21 from outside hollow tube 3. The hollow tube 3 and the aluminum conductor 16 are deformed, where joint assembly 22 is then formed. A high normal force is achieved between the aluminum conductor 16 and deformed hollow tube 3′ within compressed length 21. The compressed length 21 maintains electrical integrity and mechanical retention between the aluminum conductor 16 and deformed hollow tube 3′. A certain clearance length B 23 of the hollow tube 3 and aluminum conductor 16 is not deformed. The clearance 20 is still maintained between the non-deformed hollow tube 3″ and the aluminum conductor 16.

Referring to FIG. 7, after the aluminum conductor 16 is compressed within the deformed hollow tube 3″, melted metal filler is applied into the clearance length 23. A metallic bond 33 is formed between the aluminum conductor 16 and the conductive hollow tube 3″. At the same time, melted metal filler coats the end surface 34 (shown in FIG. 6) of the aluminum conductor 16, which is said metallic coating 27. FIG. 8 is a cross section taken at location A-A in FIG. 6, which shows the details of the metallic bond 33. The length of the metallic bond 33 and perimeter of the aluminum conductor 16 are pre-specified such that the metallic bond 33 passes a certain electrical current from a non-deformed hollow tube 3″ to the aluminum conductor 16. The metallic bond also provides certain mechanical integrities between the aluminum conductor and the conductive hollow tube. The metallic coating 27 on end surface 34 of the aluminum conductor 16 isolates the aluminum conductor from the air.

Referring to FIG. 9, again, for certain applications, metallic seals are not formed before compressing the aluminum conductor into hollow tube. For these cases, the melted metal filler is applied on at least one side of the two-arms 6 and the top seam 10 of the hollow tube. This forms a metallic seal 25 along the slit 8 and the seam 5 of two-arms, and a metallic seal 26 along the top seam 10 of hollow tube 3′ and 3″. It may use one operation to produce metallic seals 25, 26, metallic bond 33, and metallic coating 27. Again, the advantage is that the transition opening 9 allows a melted metal filler flowing in to make any metallic bonds between the aluminum conductor and the terminal conductor.

Beside that the transition opening, two-arms, and metallic seals offer many advantages, additionally, it may use only one operation to produce metallic seals, the metallic bond, and the metallic coating. Again, two-arms 6, two metallic seals 25 and 26, and the edge of the transition opening provide a unique sealing structure for shrinkable adhesive tube.

Referring to FIG. 10 and FIG. 11, an adhesive tube 28 is made of shrinkable material under the heat. The inside of the tube is coated with adhesive material 29 shown in FIG. 11. The adhesive tube 28 is jacked over the joint assembly 22. It shields the certain cover length C 30 from the aluminum conductor insulation 17 and all the way to two-arms 6. Under the heat, the adhesive tube 28 is shrunken to tightly fit the outside contour of the covered length 30. FIG. 11 is a longitudinal section view of FIG. 10, the two-arms 6 and its metallic seal 25 are nested or glued into adhesive material 29 of the shrunken tube 28. Consequently, the covered length 30 is sealed up from foreign fluid intruding at the two-arm 6 side. FIG. 12 is taken at location B-B in FIG. 11, where the edge 32 of transition opening 9 is nested with the adhesive material 29 which further seals the transition opening 9 along its edge 32. Back to FIG. 11, the outside surface of a non-deformed hollow tube 3″ and its metallic seal 26 are glued within the adhesive material 29 that further seals the outside surface of the non-deformed hollow tube 3″. The shrunken tube 28 covers the certain insulation length D 31 of the aluminum conductor insulation 17. The adhesive tube 28 is shrunken and tightly glued with the insulation length 17. The covered length 30 is sealed from any foreign fluids intruding at the insulation 17 side. Therefore, the connection of aluminum connector and conductive terminal is completed sealed from the environment.

### Conclusion

The invention of this connection is a cost effective solution and a reliable joint mechanically, electrically and environmentally. Due to the fact that terminal 1 can be produced by progressive tooling die, the terminal tongue 2 remains flexible in shape and structure. The folded two-arms 6 with at least one material thickness and its metallic seal(s) 25 provides a sealing structure for adhesive material 29 if the adhesive tube 28 is applied on them. The transition opening 9 allows the use of any existing soldering processes but not limited to these processes. It can be sealed along its edge if the adhesive tube 28 is laid over it. The non-deformed hollow tube 3″ and its metallic seal 26 provide a sealing surface for adhesive material 29 if the adhesive tube 28 is applied on them.

The oversized conductive hollow tube 3 and undersized aluminum conductor 16 create a clearance for filling metal filler and creating a metallic bond 26. The metallic bond 26 inside the clearance length 23 maintains electrical and mechanical integrity between the non-deformed hollow tubes 3″ (conductive metal) and the aluminum conductors 16. Also, the compressed length 21 maintains certain electrical and mechanical integrities between non-deformed hollow tube 3″ (a typical conductive metal) and the aluminum conductor 16.

The covered length 30 is sealed at the aluminum insulation 17 side by the shrunken tube 28 and all the way to opposite side with multiple redundant seals. The redundant seals include the shrunken tube 28 seals two-arm 6 with its metallic seal(s) 25, transition opening 9 along its edge 32, and outside surface of non-deformed hollow tube with the metallic seal. The aluminum conductor 16 is isolated by metallic bond 26 and metallic coating 27 from air.

I claim:

1. The conductive metal terminal consists of a terminal tongue, a hollow tube, and a transition section connected to the terminal tongue and the hollow tube. The terminal is formed from a metal blank. The terminal tongue can be formed in various shapes and three dimensional structures. The transition section starts with folded two arms. The two arms are at least one material thickness and have a cross section of a V-shape or rectangular shape. Then, the transition section contains a transition opening with a specified shape. It ends at the hollow tube. The hollow tube can be a cylindrical shape or an oval shape with a seam at the top.

2. The terminal of claim 1, which further comprises the metal blank consisting of a tongue portion, two arms, two specified undercuts, and a rectangular portion.

3. The terminal of claim 2, which further comprises forming the blank into a three dimensional terminal structure, which consists of two fold arms, a seam between two arms, and a slit between the terminal tongue and the two-arms, a transition opening.

4. The terminal of claim 1, which further comprises the transition opening allowing a melted metal filler to flow in and make a metallic bond between the aluminum conductor and terminal conductor.

5. The terminal of claim 4, which further comprises the metal filler being one of any meltable metal alloys such as any one of solder alloys but not limited to these solder alloys.

6. The terminal of claim 4, which further comprises the transition opening providing a feasible way to use existing soldering processes such as dip soldering, wave soldering, and reflow soldering but not limited to these process.

7. The terminal of claim 3, which further comprises metallic seals being formed on at least one side of the slit, the seam of two-arms, and the seam on top of hollow tube after applying metal filler for certain applications.

8. The terminal of claim 7, which further comprises two-arms, two metallic seals, the edge of transition opening, and outside surface of hollow tube providing a unique sealing structure for the shrinkable adhesive tube.

9. The conductive metal terminal consists of a terminal tongue, a hollow tube, and a transition section connected to the terminal tongue and the hollow tube. The terminal is formed from a metal blank. The terminal tongue can be formed in various shapes and three dimensional structures. The transition section starts with folded two arms. The two arms are at least one material thickness and have a cross section of a V-shape or rectangular shape. Then, the transition section contains a transition opening with a specified shape. It ends at the hollow tube. The hollow tube can be a cylindrical shape or an oval shape with a seam at the top.
The under sized aluminum conductor is inserted into the over sized conductive hollow tube, which creates a clearance between the two conductors. A bias pressure is applied on the certain length from outside hollow tube such that the hollow tube is deformed and that subsequently the aluminum conductor is compressed in certain length;
A certain length of the hollow tube and its inside aluminum conductor is not deformed. The clearance is still maintained in said clearance length between conductive hollow tube and the aluminum conductor;
A metal filler is filled in the clearance length and forms a metallic bond between the aluminum conductor and the conductive hollow tube. At the same time, the metal filler coats the end surface of the aluminum conductor;
The shrunken tube seals the certain length of the aluminum insulation and all the way to the two-arms where have redundant seals.

10. The terminal of claim 9, which further comprises the metal blank consisting of a tongue portion, two arms, two specified undercuts, and a rectangular portion.

11. The terminal of claim 10, which further comprises forming the blank into a three dimensional terminal structure, which consists of two fold arms, a seam between two arms, and a slit between the terminal tongue and the two-arms, a transition opening.

12. The terminal of claim 9, which further comprises the transition opening allowing a melted metal filler to flow in and make a metallic bond between the aluminum conductor and terminal conductor.

13. The terminal of claim 12, which further comprises the metal filler being one of any meltable metal alloys such as any one of solder alloys but not limited to these solder alloys.

14. The terminal of claim 12, which further comprises the transition opening providing a feasible way to use existing soldering processes such as dip soldering, wave soldering, and reflow soldering but not limited to these process.

15. The terminal of claim 11, which further comprises metallic seals being formed on at least one side of the slit, the seam of two-arms, and the seam on top of hollow tube after applying metal filler for certain applications.

16. The terminal of claim 15, which further comprises two-arms, two metallic seals, the edge of transition opening, and outside surface of hollow tube providing a unique sealing structure for the shrinkable adhesive tube.

17. The terminal of claim 9, which further comprises a high normal force being achieved between the aluminum conductor and the deformed hollow tube within compressed length.

18. The terminal of claim 17, which further comprises high normal force maintaining certain mechanical and electrical integrities between the deformed hollow tube and the aluminum conductor.

19. The terminal of claim 9, which further comprises the length of metallic bond and perimeter of the aluminum conductor being pre-specified such that the metallic bond passes certain electrical current from the non-deformed hollow tube to the aluminum conductor.

20. The terminal of claim 9, which further comprises the metallic bond providing certain mechanical integrities between the aluminum conductor and the conductive hollow tube.

21. The terminal of claim 9, which further comprises the metallic bond with metallic coating on end surface of the aluminum conductor isolating the aluminum conductor from the air.

22. The terminal of claim 15, which further comprises the metallic seals being formed on at least one side of slit, the seam of two-arms, and the seam on top of hollow tube if metallic seals are not formed before the aluminum conductor is compressed within the deformed hollow tube for certain applications.

23. The terminal of claim 22, which further comprises that metallic seals combining metallic bond and metallic coating may be produced by one operation.

24. The terminal of claim 22, which further comprises two-arms combining with two metallic seals and transition opening providing a unique sealing structure for the shrinkable adhesive tube.

25. The terminal of claim 9, which further comprises that two-arm and metallic seals formed along the seam and slit are nested and sealed within the adhesive material of shrunken tube.

26. The terminal of claim 9, which further comprises that a transition opening is nested and sealed within the adhesive material of shrunken tube.

27. The terminal of claim 9, which further comprises that the outside surface of the non-deformed hollow tube and its seam filled with metallic seals are nested and sealed within the adhesive material of the shrunken tube.
